(19) United States
(12) Patent Application Publication
(10) Pub. No.: US 2002/0198609 A1
(43) Pub. Date: Dec. 26, 2002

(54) Method and apparatus for regulating network access to functions of a controller

(76) Inventor: Carl N. Baron, Avon, OH (US)

Correspondence Address: Attention: David H. Brinkman, Wood, Herron & Evans, L.L.P., 2700 Carew Tower, 441 Vine Street, Cincinnati, OH, 45202, US

(21) Appl. No.: 09/886,895

(22) Filed: Jun. 21, 2001

(51) Int. Cl. G05B 13/02; G05B 19/18; G06F 15/16

(52) U.S. Cl. 700/48; 700/49; 700/65

(57) ABSTRACT

A method and apparatus for regulating Internet or Intranet access to selected functions of a machine controller based upon a user network address.

### FIELD OF THE INVENTION

The present invention relates generally to control systems for controlling operation of a machine and, more particularly, to a control system for a machine that is adapted for use by local and remote users in a distributed network environment.

### BACKGROUND OF THE INVENTION

The capability to closely monitor and control the operation of complex machinery is vital to industry. Sophisticated machines, such as liquid dispensing systems, require access to and control of operating parameters of the system to ensure proper set-up and operation of the system during a dispensing cycle.

Liquid dispensing systems generally include one or more dispensing valves that may be opened and closed during a dispensing cycle to achieve a desired liquid dispense pattern on a substrate. The liquid could be, but is not limited to, adhesives, sealants, caulks or similar liquid materials. Successful operation of liquid dispensing systems depends upon the effective management of a number of factors, such as the pressure, flow rate and temperature of the liquid and the size of a liquid bead. Other variables that must be managed may relate to the readiness state of pumps and dispensing guns, as well as to the availability of spare parts.

Manufacturers conventionally rely on programmable controllers to coordinate and manage these interdependent factors. A typical controller may monitor and direct dispensing processes according to program protocol and user input. Onsite supervisory personnel may monitor and input control commands into the controller during a dispensing operation. For instance, a technician may push a controller button to ascertain the pressure reading of a supply hose. As such, the controller may energize a sensing component configured to measure line pressure.

Despite user-friendly improvements to the controller interface, access to controller processes remain limited. In part, this localization is by design. Complex dispensing processes may require the security and continuity provided by relatively few highly trained technicians. Efforts to enable remote monitoring of controller processes utilizing Internet or Intranet connectivity may compromise such supervision, while presenting still other security concerns.

For example, the Internet supports hypertext links that provide for universal access in customized interface formats. Browser software accesses Internet sites to read and interact with posted text, audio, images and additional links. The World Wide Web of the Internet supports a network of such screens stored on server computers throughout the world.

While Internet-based systems succeed in allowing real-time remote access, such availability may nonetheless be ill-suited for liquid dispensing systems or other machine environments. Namely, World Wide Web connectivity has no way to differentiate traffic with regard to its priority or purpose. Further, conventional fire walls and routers may remain susceptible to computer hackers and unauthorized access, translating into substantial manufacturing losses. Conventional security techniques may further compromise the availability of useful information to legitimate remote users. Such users may include management, marketing and shipping personnel. Consequently, the indiscriminate and/or inadequate access afforded by some networked configurations may be inappropriate for a complex and sensitive liquid dispensing environment or other machine environment.

### SUMMARY OF THE INVENTION

The present invention overcomes the foregoing and other shortcomings and drawbacks of the machine control systems and methods heretofore known. While the invention will be described in connection with certain embodiments, it will be understood that the invention is not limited to these embodiments. On the contrary, the invention includes all alternatives, modifications and equivalents as may be included within the spirit and scope of the present invention.

One embodiment of the present invention provides a means of regulating remote access to selected functions of a controller of a machine. Access to control and monitoring functions of the controller may be based upon the address of a user within a computer network. More particularly, a remote or local network user may interface with a controller configured to oversee and control dispensing operations.

In a preferred embodiment, the controller may comprise two different boards. A first, common control board may house memory for a central processing unit (CPU). The common control board may additionally handle inputs and outputs to hardware of the machine.

A personal computer (PC) may constitute a second component, or operator interface board, of the controller. An operating system, such as Windows 2000, may maintain a web server on the computer suited to relate operational information and commands. The PC may couple to a flat panel screen, as well as to a hard drive and diskette/floppy drive. The PC may further electronically couple to the control board via a serial port, such as a commercially available RS232 port. An Ethernet chip of the PC may enable the interface board to remotely connect to other networked computers. As such, enabled browsers of the networked computers may access interactive screens maintained by the web server.

One embodiment may evaluate a network address for each networked PC. For instance, the operator interface board may use an Internet protocol (IP) address to uniquely identify the computer of a user. When the browser of the networked user PC communicates with the web server, the operator interface board may record the IP address of the computer. The operator interface board may compare the sampled address with a stored local address maintained within a database. The interface board may use the results of the comparison to determine if it corresponds to a local or remote PC.

Program code of the embodiment may use the location determination as a basis for allowing access to the web server of the host PC. For instance, the embodiment may grant a local PC user unrestricted rights to status, set-up and configuration web screens. From such screens, the local user may both monitor and control the operation of dispensing hardware. Conversely, program code may limit the access of external users to status or diagnostic reports. As discussed below, such an arrangement may safeguard sensitive dispensing processes from unauthorized modification, while still allowing for monitoring of production status by a wider range of users.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram illustrating remote and local user interfaces to a controller of a machine according to the principles of the present invention;

FIG. 2 is a representative screen published by the web server of FIG. 1;

FIG. 3 is block diagram illustrating the functionality of the controller of FIG. 1; and

FIG. 4 is a flow diagram illustrating process steps suitable for implementation within the user interface environment of FIG. 1 for regulating access to selected functions of the controller.

### DETAILED DESCRIPTION OF SPECIFIC EMBODIMENTS

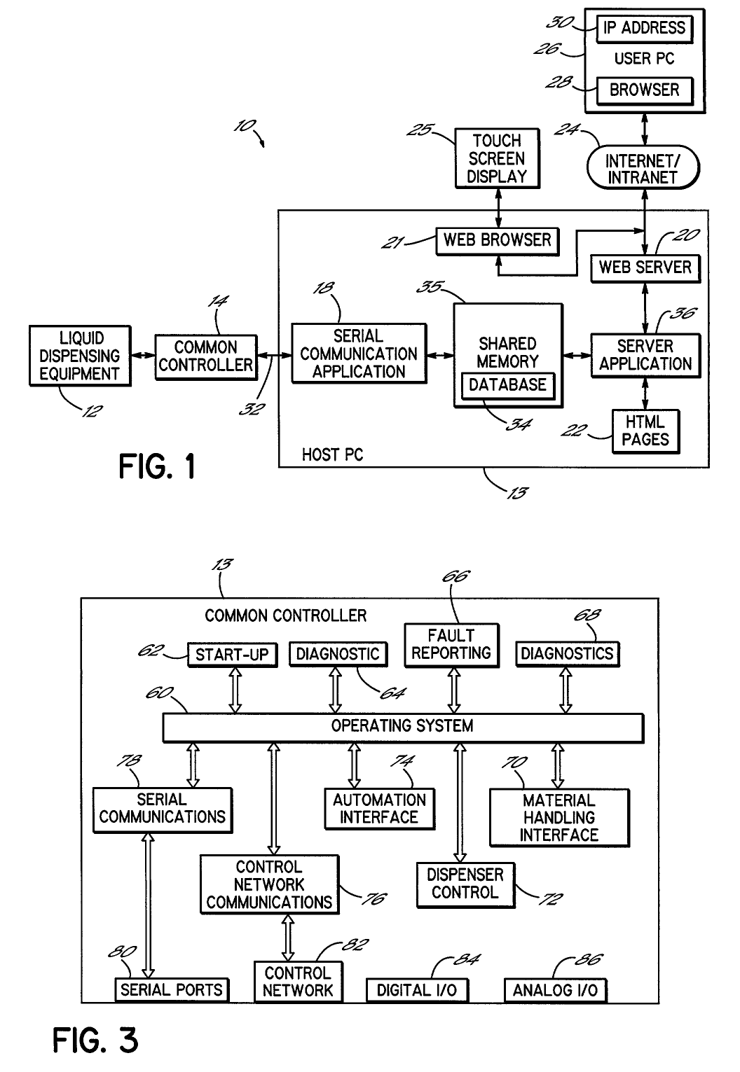

With reference to the Figures, and to FIG. 1 in particular, a remote and local user interface 10 to a machine 12 is shown in accordance with the principles of the present invention. Generally, the remote and local user interface 10 includes a host personal computer (PC) 13 that serves as a local user interface to a common controller board 14. The board 14 may be configured to control and monitor operating parameters of the liquid dispensing system 12. A serial communications application 18 running on the PC 13 may relate information and commands to and from the controller board 14. The PC 13 may further host a web server 20 and viewable Hypertext Markup Language (HTML) screens 22. The web server 20 may publish the screens 22 via the Internet or Intranet 24 to appropriate network connections.

More particularly, a user may log into a remote computer 26 having a web browser 28. The browser 28 may access a network of computers, such as the Internet or Intranet 24, to view a web site published by the host PC 13. The user may be on either a remote network PC 26 or the local personal computer 13. The user may wish to oversee a dispensing operation, check the operating status of a particular component or parameter, or may wish to adjust the operation of a hardware component. As discussed above, browser requests may reflect varied functions of different users. For instance, a highly trained technician or engineer wishing to adjust conveyor speed may have different requirements than a production manager checking on production progress.

The web server 20 of the host PC 13 may publish the web site on the Internet or Intranet 24. The web server 20 may contain a known network interface programming for the purpose of facilitating communication exchanges. The interface may function to sample the IP address of the user attempting to access the web server 20 to determine if the user is accessing the web server 20 via a remote PC 26 or the local web server 20 using a touch screen display 25. The web server 20 may ultimately restrict a user's access to the HTML screens 22 and associated controls based upon a determination of the user's location within the network.

For instance, the web server 20 may receive and evaluate a transmission from a user. As above, the transmission may originate from a remote or local user requesting access to the server 20. A register of the interface board/host PC 13 may sample an IP address 30 of the user transmission. That is, the register may record the 16 bit unique identifier of the user's personal computer 26 within the memory of the host PC 13.

In response, program code executing within the operating system of the host PC 13 may access the database 34. The database may maintain a list of addresses for networked machines, and may at least contain the address of the local PC 13. The web server 20 may assign permission fields to each received network address. Such permission fields may reflect the location within the network of a transmitting computer. In this manner, the embodiment may categorize each machine in the database 34 by whether it is local or remote to the network configuration of the host PC 13. The program code may use this categorization to determine server access and permissions. Namely, program code may direct the web server to deny or allow access to particular HTML screens 22 based upon the determined network location. Of note, different permissions will allow access to different subsets of published web screens 22.

The server 20 may maintain hyperlinks to several HTML pages or screen 22 containing diagnostic and control features. A server application 36 of the host PC 13 may work in conjunction with the web server 20 to build HTML web screens that are responsive to user inputs. A user interface feature of the web site and underlying HTML links may be divided into a series of web screens. Each screen may provide a unique level of functionality relating to a dispensing operation. Web architects may further divide each web screen into sub-panels. Each sub-panel may convey a specific piece of information. This segmentation may assist the web server in presenting data and control options tailored to the determined permission of a given user. Such precaution and structure may facilitate processing of requests, while safeguarding the integrity of control systems.

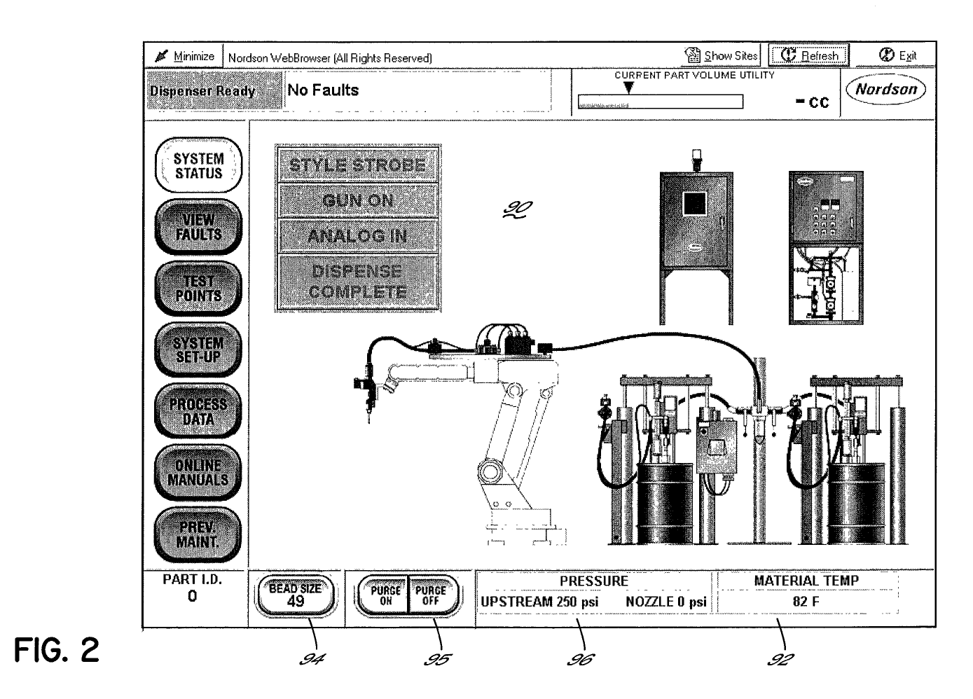

An exemplary hyperlink may divulge the overall state of the liquid dispensing system 12. Particularly, a “system status” HTML screen may comprise a series of sub-panels addressing diagnostic aspects of production. The representative screen of FIG. 2 illustrates one such embodiment. The screen generally displays a schematic representation 90 of a dispensing gun, pump, thermodynamic controls, and robotics equipment. A sub-panel 94 of the status screen may relate to the bead size of a dispensed fluid. Still other sub-panels may relate the temperature 92, volume 96 and pressure 95 of a liquid adhesive. The status screen may display general system fault information, and may additionally hyperlink to other approved HTML screens 22 of FIG. 1.

One such screen may embody a “view faults” screen. This screen may enable a user to evaluate potential problems with particular dispensing components. For instance, a program resident on the web server may inform the user of a low pressure occurrence in a supply hose. Another fault warning communicated from the HTML screen may indicate a loss of synchronization between the dispensing gun and the conveyor motor.

One sub-panel configuration of the view faults screen may allow a user to view only a most recent fault. Another user may initiate the display of a fault log on the web screen. Such a log may chronologically list a predetermined number of recent faults, enabling comprehensive error analysis. A schematic representation of a fault may be displayed on another sub-panel in order to provide a user with spatial perspective. Still another sub-panel may display instructions regarding appropriate remedy measures. As discussed below, an approved IP address may enable a particular user to correct a faulty parameter online. As above, the sub-panels may include hyperlinks to other screens hosted on the web site.

For instance, the user may link to a screen containing online manuals. Web designers may tailor other screens of the web site to reflect binary monitoring of select inputs and control variables. For example, a screen may present a listing of vital system diagnostics, such as “gun on/off,” “dispense complete” and “dispenser ready.” A simulated LED next to each category listing may indicate whether the condition embodied by the category is present. For instance, the screen may display a red or green circle next to the listed condition. Other warning indicators may be programmably configured to communicate conditions to a supervisor monitoring the system via the Internet 24.

Still other screens may regard periodic maintenance of a dispensing system. For instance, one screen may inventory a listing of equipment, to include their installation date and expected lifetime. Other displayed metrics may relate to the performance or accuracy of the part. For instance, an HTML screen may chart a value representative of how much fluid was dispensed, as compared to how much a gun was programmed to dispense. A progression of such stored comparisons may be simultaneously displayed or mathematically manipulated in such a manner as to apprize a user of a part's performance.

Still another screen may calculate a date when a particular part should be replaced. A schematic displayed from a sub-panel may highlight the part in red or yellow to alert appropriate supervisory personnel. Displayed maintenance information may further include a part number, warranty and other information relating to part replacement. In this manner, such a web screen may assist operators in ensuring the continued integrity of dispensing equipment and applications.

Other web screens may allow approved users more direct control over dispensing operations. For example, program code may allow a local networked user to access a system “set-up” screen. A set-up HTML screen may allow a user to configure aspects of the common controller board. For instance, sub-panels of the screen may accommodate user inputs. Exemplary inputs may specify preferences, system clock increments, delay timers and alarm trips. Other set-up parameters may concern flow rate and periodic purging operations.

An “equipment” web screen may graphically represent the operation of machinery connected to the controller. As such, a local network user may use a browser to view the screen. Through the browser and screen options, the user may send commands operable to energize particular components and systems represented on the screen. For instance, the operator may increase the speed of the adhesive pump motor by clicking on the schematic motor, or by selecting a speed from a pull-down menu. Another option available via the web server 20 may allow a user to manipulate a display of lights, or incrementally adjust the speed of a conveyor belt. Similarly, a user may type in, or otherwise select, commands operable to modify a dispensing pattern. Still another control option offered via the HTML screen 22 may activate a second dispensing gun.

Program code may assign path names or coded values to each hyperlink/HTML screen 22. The program code may associate the path name with a set of permissions maintained by the database 34. These permissions may correspond to those associated with networked computers in the database 34. The program code may ensure that a requesting PC 26 has all permissions required by an HTML screen 22 before presenting a hyperlink to the screen. In this manner, the program code may evaluate permissions derived from the IP address 30 of the transmitting PC 26 to determine if the PC 26 may access a given link. For example, a remote user may have access to only a subset of the HTML screens 22 published by the web server 20. The subset, derived from header text of the PC's request, may exclusively contain status information.

In such an embodiment, permission fields within the database 34 may dictate that remote users be denied access to HTML screens 22 that allow direct control of a dispensing operation. As discussed above, this precaution ensures against deliberate and accidental meddling with a dispensing operation. The technique further promotes continuity and familiarity among those personnel approved for such access.

After determining access privileges of the requesting PC 26, a handler of the web server 20 may process the request and allow access to an appropriate HTML screen. An authorized user may then generate a request from the HTML screen. The web server 20 may evaluate header text of a message to determine whether it embodies a data request or a command event. The operating system may process the request by sending a formatted message to the serial communications application 18.

This feature of the host PC 13 may act as a translator or bridge between the common controller board 14 and the web server 20. Namely, the serial communications application 18 decodes text-based messages from the common controller 14 such that the server 20 may process them. Further, the serial communications application 18 may utilize a transport layer protocol such as a transmission control protocol (TCP) that offers connection-oriented stream service between the common controller 14 and the dispensing equipment 16. The operating system may format the message using a protocol such as HTTP. Conversely, the serial communications application 18 may encode instructions from the web server 20 so that the common controller 14 may execute commands generated from the web screens 22.

The encoded instructions may enter the common controller 14 from the host PC 13 through a serial port 32. An RS232 connection may provide a coupling means in a preferred embodiment. The common controller 14, as illustrated in the block diagram of FIG. 3, may manage a dispensing apparatus 72 and associated material handling equipment 70. The common controller 14 may incorporate a microprocessor having an address range of greater than one megabyte.

The common controller may execute an operating system 60 on the microprocessor in order to schedule and coordinate application tasks. Exemplary tasks include start-up/initialization procedures 62, fault 66 and diagnostic 68 reporting, as well as control of dispensers 72 and pumps 70. A serial communications function 78 of the common controller 14 may process messages to and from a serial port 80. As discussed above, this connectivity may execute in conjunction with a control network communications function 76 to enable approved network users 82 access to the controller 14. In this manner, approved user may initiate tasks within the common controller via the Internet, while restricting access to the same by unauthorized users.

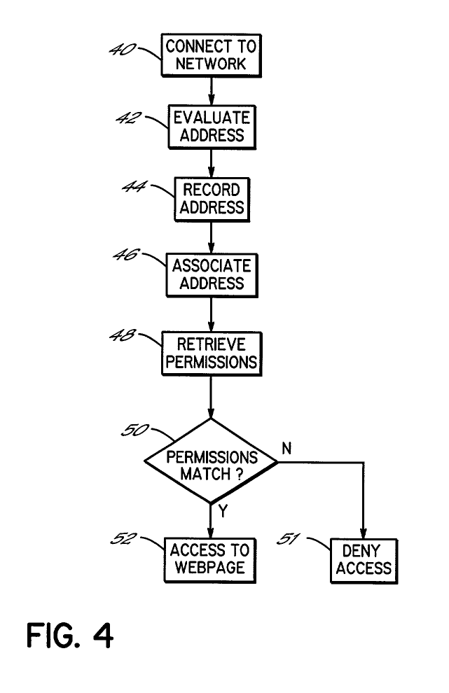

The flowchart of FIG. 4 illustrates process steps suited for execution within the environment of FIG. 1. At block 40, a user may connect into a network of computers, such as the Internet. The network may include a host PC running program code of the embodiment. The host PC may act as a primary interface for the input of user instructions to the common controller. The host PC may additionally support an Ethernet-based web server configured to publish HTML screens on the Internet. Still another feature of the PC may act as a translator of serial messages from and to the common controller board.

At block 42, the program code of the host PC may evaluate a message transmitted via the World Wide Web from the user computer. A header portion of the message may contain an IP address. Text within the body of the message may further request access to an HTML screen maintained by a web server of the host PC. The screen may present a user interface configured to generate a status or control data relating to the operation of the dispensing system. The requested screen may further be associated with a set of permissions stored within a database. As such, the PC of the user must exhibit those permissions to gain access to the web site.

A register of the host PC may sample the IP address of the user PC at block 42. Alternatively, the PC may assign or recognize some other identifier associated with the user computer. One embodiment may record the identifier or IP address within shared storage of the host PC at block 44. At block 46, the embodiment may compare the sampled address and evaluate it against a plurality of addresses stored within the database.

Program code may associate the IP address recorded at block 44 with an address field of the database. In a preferred embodiment, the database stores the address of the host PC. As such, program code may compare the received IP address with the stored, local PC address. The address field may be logically associated along with other data that relates to a networked computer. Such data may include a set of permissions assigned to the networked computer. Where a received network address is not matched within the database, a set of default permissions may be assigned by the web server to the received address. For instance, one embodiment may discern that a received address does not correspond to a stored, local address, so the received address may be assigned a set of permissions that restricts access to a subset of published screens. In this manner, the embodiment may retrieve at block 48 a series of permissions associated with the IP address evaluated by the database.

As discussed above, permissions may reflect the relationship or location of the user PC within the network. For instance, the program code may recognize whether the user PC is locally or remotely connected to the network. The program code may grant local users greater permissions than remote users. For instance, a local user may have unrestricted access privileges to include HTML screens that allow hardware control. Meanwhile, program code may restrict the access of remote users to status and monitoring screens.

After retrieving permissions of the user PC at block at block 48, the embodiment may verify that the user has access to a requested web screen. At block 50, program code may ensure that the permissions of the user match those required by the web screen. Should the requisite permissions be present, the embodiment may allow access to the appropriate web screen at block 52. In this manner, the embodiment may regulate and safeguard access to dispensing systems while allowing remote monitoring and control for appropriate personnel.

While the present invention has been illustrated by a description of various embodiments and while these embodiments have been described in considerable detail, it is not the intention of the applicants to restrict or in any way limit the scope of the appended claims to such detail. For instance, password techniques may be employed to particularly identify a user in addition or in the alternative to IP address recognition. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method of regulating network access to selected functions of a controller of a machine, wherein the controller is coupled to a network having a web server that publishes a plurality of web screens configured to control the selected functions of the controller, and at least one remote computer connected to the web server that receives the published web screens, the method comprising:
identifying a network address of a user accessing the web server via the network; and
restricting access of the user to selected published web screens of the plurality of web screens published by the web server based upon the identified address of the user.

2. The method according to claim 1, wherein a user accessing the web server via the at least one remote computer is restricted in access to a subset of the plurality of published web screens.

3. The method according to claim 1, wherein a user accessing the web server via the web server is unrestricted in access to the plurality of published web screens.

4. A method for regulating access to selected functions of a controller of a liquid dispensing system from a computer network, wherein a server application is coupled to the computer network and to a serial communications application communicating with the controller, the method comprising:
publishing a plurality of web screens from the server application;
applying and receiving signals relating to operating parameters of the liquid dispensing system via the plurality of web screens published by the server application;
communicating the signals between the controller and the server application.

5. An apparatus for regulating access to selected functions of a controller of a machine from a computer network, comprising:
a web server operatively coupled to said controller, wherein said web server has a network address and publishes a plurality of web screens on said network configured to control the selected functions of the controller;
at least one remote computer coupled to said web server and having a unique network address;
program code running on said web server configured to identify a network address of a user accessing said web server via said at least one remote computer or said web server and to restrict access of the user to selected published web screens based upon said identified network address.

6. The apparatus of claim 5, wherein said program code provides restricted access to a subset of said plurality of published web screens for a user accessing said web server via said at least one remote computer.

7. The apparatus of claim 5, wherein said program code provides unrestricted access to the plurality of web screens for a user accessing the web server via the web server.

8. An apparatus for regulating access to selected functions of a controller of a liquid dispensing system from a computer network, comprising:
a server application connected to said computer network and operable to publish a plurality of web screens, wherein said server application may apply and receive signals relating to operating parameters of said liquid dispensing system;
a serial communication application coupled to said controller and said server application and configured to apply said signals between said controller and said server application.
